(19) United States
(12) Patent Application Publication
(10) Pub. No.: US 2009/0036319 A1
(43) Pub. Date: Feb. 5, 2009

(54) Methods and systems for pairwise filtering candidate probe nucleic acid sequences

(76) Inventors: Nicholas M. Sampas, San Jose, CA (US); Brian Schane Giles, Fremont, CA (US); Peter G. Webb, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/888,059

(22) Filed: Jul. 30, 2007

(51) Int. Cl. C40B 30/02; C40B 30/04; C40B 60/04

(52) U.S. Cl. 506/8; 506/35; 506/9

(57) ABSTRACT

Aspects of the invention include methods of systems of pairwise filtering candidate probe nucleic acid sequences. Aspects of the invention further include methods and systems of selecting candidate probe nucleic acid sequences from plurality thereof, which methods and systems employ a pairwise elimination ranked record of a plurality of candidate probe nucleic acids for a genomic region of interest.

### INTRODUCTION

Many genomic and genetic studies are directed to the identification of differences in gene dosage or expression among cell populations for the study and detection of disease. One type of such differences is referred to in the art as copy number variations. Copy Number Variations (CNV's) are duplications and deletions of genomic material that vary between individuals. Another source of genomic copy number variation is in cancer, where somatic events alter the distributions of genomic copy number in tumors and pre-cancerous lesions.

Comparative genomic hybridization (CGH) is one approach that has been employed to detect the presence and identify the location of CNVs, e.g., as manifested in amplified or deleted genomic sequences. In one implementation of CGH, genomic DNA is isolated from normal reference cells, as well as from test cells (e.g., tumor cells). The two nucleic acids are differentially labeled and then simultaneously hybridized in situ to metaphase chromosomes of a reference cell. Chromosomal regions in the test cells which are at increased or decreased copy number relative to the reference cells can be identified by detecting regions where the ratio of the signals from the two distinguishably labeled nucleic acids is altered. For example, those regions that have been decreased in copy number in the test cells will show relatively lower signal from the test nucleic acids than the reference compared to other regions of the genome. Regions that have been increased in copy number in the test cells will show relatively higher signal from the test nucleic acid.

In a recent variation of the above traditional CGH approach, the immobilized chromosome elements have been replaced with a collection of solid support surface-bound polynucleotides, e.g., an array of BAC (bacterial artificial chromosome) clones or cDNAs. Such approaches offer benefits over immobilized chromosome approaches, including a higher resolution, as defined by the ability of the assay to localize chromosomal alterations to specific areas of the genome.

### SUMMARY

Methods and systems for pairwise filtering of a plurality of candidate probe nucleic acid sequences for a genomic region of interest are provided. Embodiments of the methods include (a) providing a plurality of candidate probe nucleic acid sequences for a genomic region of interest; (b) sorting the plurality of candidate probe nucleic acid sequences from smallest genomic distance to largest genomic distance between neighboring candidate probe nucleic acid sequences to produce a sorted plurality of candidate probe nucleic acid sequences; (c) evaluating a probe property value for a neighboring pair of candidate probe nucleic acid sequences from the sorted plurality to identify a first member of said neighboring pair with a more desirable probe property value than a second pair member of said neighboring pair; (d) removing the second pair member from said plurality; and (e) reiterating the sorting, evaluating and removing steps at least once to produce a final collection of candidate probe nucleic acid sequences. Also provided are methods and systems for selecting one or more candidate probe nucleic acid sequences from a plurality of candidate probe nucleic acids for a genomic region of interest. Aspects of these methods include inputting a request for candidate probe nucleic acids for a genomic region of interest into the system that a pairwise elimination ranked record of a plurality of candidate probe nucleic acids for the genomic region; and receiving from the system a subset of the plurality that has been selected from said ranked record to match the request.

### BRIEF DESCRIPTION OF THE FIGURES

FIGS. 1 to 22 provide views of various binary tree structures that are produced during binary tree sort embodiments of the invention.

FIG. 23 is a flow chart of a pairwise filtering method according to an embodiment of the invention.

FIG. 24 schematically illustrates a system according to an embodiment of the invention.

### DEFINITIONS

The term “nucleic acid” and “polynucleotide” are used interchangeably herein to describe a polymer of any length composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single stranded nucleotide multimers of from about 10 to 100 nucleotides and up to 200 nucleotides in length, or longer, e.g., up to 500 nt in length or longer. However, in representative embodiments, oligonucleotides are synthetic and, in certain embodiments, are under 50 nucleotides in length.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other nucleic acids that are C-glycosides of a purine or pyrimidine base, polypeptides (proteins), polysaccharides (starches, or polysugars), and other chemical entities that contain repeating units of like chemical structure.

The term “sample” as used herein relates to a material or mixture of materials, typically, although not necessarily, in fluid form, containing one or more components of interest.

The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The phrase “labeled population of nucleic acids” refers to mixture of nucleic acids that are detectably labeled, e.g., fluorescently labeled, such that the presence of the nucleic acids can be detected by assessing the presence of the label. A labeled population of nucleic acids is “made from” a chromosome composition, the chromosome composition is usually employed as template for making the population of nucleic acids.

The phrase “surface-bound polynucleotide” refers to a polynucleotide that is immobilized on a surface of a solid substrate, where the substrate can have a variety of configurations, e.g., a sheet, bead, or other structure. In certain embodiments, the collections of polynucleotide probe elements employed herein are present on a surface of the same planar support, e.g., in the form of an array.

The term “array” encompasses the term “microarray” and refers to an ordered array presented for binding to nucleic acids and the like.

An “array,” includes any two-dimensional or substantially two-dimensional (as well as a three-dimensional) arrangement of spatially addressable regions bearing nucleic acids, particularly oligonucleotides or synthetic mimetics thereof, and the like. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a front surface of the substrate. Depending upon the use, any or all of the arrays may be the same or different from one another and each may contain multiple spots or features. A typical array may contain one or more, including more than two, more than ten, more than one hundred, more than one thousand, more than ten thousand features, or even more than one hundred thousand features, in an area of less than 20 cm² or even less than 10 cm², e.g., less than about 5 cm², including less than about 1 cm², less than about 1 mm², e.g., 100μ², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 and less than 1.5 mm, such as more than about 0.8 mm and less than about 1.2 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse-jets of either nucleic acid precursor units (such as monomers) in the case of in situ fabrication, or the previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents.

An array is “addressable” when it has multiple regions of different moieties (e.g., different oligonucleotide sequences) such that a region (i.e., a “feature” or “spot” of the array) at a particular predetermined location (i.e., an “address”) on the array will detect a particular sequence. Array features are typically, but need not be, separated by intervening spaces. In the case of an array in the context of the present application, the “population of labeled nucleic acids” will be referenced as a moiety in a mobile phase (typically fluid), to be detected by “surface-bound polynucleotides” which are bound to the substrate at the various regions. These phrases are synonymous with the terms “target” and “probe”, or “probe” and “target”, respectively, as they are used in other publications.

A “scan region” refers to a contiguous (preferably, rectangular) area in which the array spots or features of interest, as defined above, are found or detected. Where fluorescent labels are employed, the scan region is that portion of the total area illuminated from which the resulting fluorescence is detected and recorded. Where other detection protocols are employed, the scan region is that portion of the total area queried from which resulting signal is detected and recorded. For the purposes of this invention and with respect to fluorescent detection embodiments, the scan region includes the entire area of the slide scanned in each pass of the lens, between the first feature of interest, and the last feature of interest, even if there exist intervening areas that lack features of interest.

An “array layout” refers to one or more characteristics of the features, such as feature positioning on the substrate, one or more feature dimensions, and an indication of a moiety at a given location. “Hybridizing” and “binding”, with respect to nucleic acids, are used interchangeably.

By “remote location,” it is meant a location other than the location at which the array is present and hybridization occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart. “Communicating” information references transmitting the data representing that information as signals (e.g., electrical, optical, radio signals, etc.) over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. An array “package” may be the array plus only a substrate on which the array is deposited, although the package may include other features (such as a housing with a chamber). A “chamber” references an enclosed volume (although a chamber may be accessible through one or more ports). It will also be appreciated that throughout the present application, that words such as “top,” “upper,” and “lower” are used in a relative sense only.

The term “stringent assay conditions” as used herein refers to conditions that are compatible to produce binding pairs of nucleic acids, e.g., probes and targets, of sufficient complementarity to provide for the desired level of specificity in the assay while being incompatible to the formation of binding pairs between binding members of insufficient complementarity to provide for the desired specificity. Stringent assay conditions are the summation or combination (totality) of both hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions determines whether a nucleic acid is specifically hybridized to a probe. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C. In instances wherein the nucleic acid molecules are deoxyoligonucleotides (“oligos”), stringent conditions can include washing in 6×SSC/0.05% sodium pyrophosphate at 37° C. (for 14-base oligos), 48° C. (for 17-base oligos), 55° C. (for 20-base oligos), and 60° C. (for 23-base oligos). See Sambrook, Ausubel, or Tijssen (cited below) for detailed descriptions of equivalent hybridization and wash conditions and for reagents and buffers, e.g., SSC buffers and equivalent reagents and conditions.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent hybridization conditions may also include a “prehybridization” of aqueous phase nucleic acids with complexity-reducing nucleic acids to suppress repetitive sequences. For example, certain stringent hybridization conditions include, prior to any hybridization to surface-bound polynucleotides, hybridization with Cot-1 DNA, or the like.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

The term “mixture”, as used herein, refers to a combination of elements, that are interspersed and not in any particular order. A mixture is heterogeneous and not spatially separable into its different constituents. Examples of mixtures of elements include a number of different elements that are dissolved in the same aqueous solution, or a number of different elements attached to a solid support at random or in no particular order in which the different elements are not especially distinct. In other words, a mixture is not addressable. To be specific, an array of surface bound polynucleotides, as is commonly known in the art and described below, is not a mixture of capture agents because the species of surface bound polynucleotides are spatially distinct and the array is addressable.

“Isolated” or “purified” generally refers to isolation of a substance (compound, polynucleotide, protein, polypeptide, polypeptide, chromosome, etc.) such that the substance comprises the majority percent of the sample in which it resides. Typically in a sample a substantially purified component comprises 50%, preferably 80%-85%, more preferably 90-95% of the sample. Techniques for purifying polynucleotides and polypeptides of interest are well known in the art and include, for example, ion-exchange chromatography, affinity chromatography, flow sorting, and sedimentation according to density.

The term “assessing” and “evaluating” are used interchangeably to refer to any form of measurement, and includes determining if an element is present or not. The terms “determining,” “measuring,” and “assessing,” and “assaying” are used interchangeably and include both quantitative and qualitative determinations. Assessing may be relative or absolute. “Assessing the presence of” includes determining the amount of something present, as well as determining whether it is present or absent.

The term “using” has its conventional application, and, as such, means employing, e.g. putting into service, a method or composition to attain an end. For example, if a program is used to create a file, a program is executed to make a file, the file usually being the output of the program. In another example, if a computer file is used, it is usually accessed, read, and the information stored in the file employed to attain an end. Similarly if a unique identifier, e.g., a barcode is used, the unique identifier is usually read to identify, for example, an object or file associated with the unique identifier.

“Contacting” means to bring or put together. As such, a first item is contacted with a second item when the two items are brought or put together, e.g., by touching them to each other.

A “probe” means a polynucleotide which can specifically hybridize to a target polynucleotide, either in solution or as a surface-bound polynucleotide.

The term “validated probe” means a probe that has been passed by at least one screening or filtering process in which experimental data related to the performance of the probes was used as part of the selection criteria.

“In silico” means those parameters that can be determined without the need to perform any experiments, by using information either calculated de novo or available from public or private databases.

“Empirical” refers to experimental protocols that include a physical transformation of matter, such as hybridization assays in which an array is contacted with a sample.

The term “genome” refers to all nucleic acid sequences (coding and non-coding) and elements present in or originating from any virus, single cell (prokaryote and eukaryote) or each cell type and their organelles (e.g. mitochondria) in a metazoan organism. The term genome also applies to any naturally occurring or induced variation of these sequences that may be present in a mutant or disease variant of any virus or cell type. These sequences include, but are not limited to, those involved in the maintenance, replication, segregation, and higher order structures (e.g. folding and compaction of DNA in chromatin and chromosomes), or other functions, if any, of the nucleic acids as well as all the coding regions and their corresponding regulatory elements needed to produce and maintain each particle, cell or cell type in a given organism.

For example, the human genome consists of approximately 3×10⁹ base pairs of DNA organized into distinct chromosomes. The genome of a normal diploid somatic human cell consists of 22 pairs of autosomes (chromosomes 1 to 22) and either chromosomes X and Y (males) or a pair of chromosome Xs (female) for a total of 46 chromosomes. A genome of a cancer cell may contain variable numbers of each chromosome in addition to deletions, rearrangements and amplification of any subchromosomal region or DNA sequence.

By “genomic source” is meant the initial nucleic acids that are used as the original nucleic acid source from which the solution phase nucleic acids are produced, e.g., as a template in the labeled solution phase nucleic acid generation protocols described in greater detail below.

The genomic source may be prepared using any convenient protocol. In many embodiments, the genomic source is prepared by first obtaining a starting composition of genomic DNA, e.g., a nuclear fraction of a cell lysate, where any convenient means for obtaining such a fraction may be employed and numerous protocols for doing so are well known in the art. The genomic source is, in many embodiments of interest, genomic DNA representing the entire genome from a particular organism, tissue or cell type. However, in certain embodiments, the genomic source may comprise a portion of the genome, e.g., one or more specific chromosomes or regions thereof, such as PCR amplified regions produced with a pairs of specific primers.

A given initial genomic source may be prepared from a subject, for example a plant or an animal, which subject is suspected of being homozygous or heterozygous for a deletion or amplification of a genomic region. In certain embodiments, the average size of the constituent molecules that make up the initial genomic source typically have an average size of at least about 1 Mb, where a representative range of sizes is from about 50 to about 250 Mb or more, while in other embodiments, the sizes may not exceed about 1 Mb, such that they may be about 1 Mb or smaller, e.g., less than about 500 Kb, etc.

In certain embodiments, the genomic source is “mammalian”, where this term is used broadly to describe organisms which are within the class mammalia, including the orders carnivore (e.g., dogs and cats), rodentia (e.g., mice, guinea pigs, and rats), and primates (e.g., humans, chimpanzees, and monkeys), where of particular interest in certain embodiments are human or mouse genomic sources. In certain embodiments, a set of nucleic acid sequences within the genomic source is complex, as the genome contains at least about 1×10⁸ base pairs, including at least about 1×10⁹ base pairs, e.g., about 3×10⁹ base pairs.

Where desired, the initial genomic source may be fragmented in the generation protocol, as desired, to produce a fragmented genomic source, where the molecules have a desired average size range, e.g., up to about 10 Kb, such as up to about 1 Kb, where fragmentation may be achieved using any convenient protocol, including but not limited to: mechanical protocols, e.g., sonication, shearing, etc., chemical protocols, e.g., enzyme digestion, etc.

Where desired, the initial genomic source may be amplified as part of the solution phase nucleic acid generation protocol, where the amplification may or may not occur prior to any fragmentation step. In those embodiments where the produced collection of nucleic acids has substantially the same complexity as the initial genomic source from which it is prepared, the amplification step employed is one that does not reduce the complexity, e.g., one that employs a set of random primers, as described below. For example, the initial genomic source may first be amplified in a manner that results in an amplified version of virtually the whole genome, if not the whole genome, before labeling, where the fragmentation, if employed, may be performed pre-or post-amplification.

### DETAILED DESCRIPTION

Methods and systems for pairwise filtering of a plurality of candidate probe nucleic acid sequences for a genomic region of interest are provided. Embodiments of the methods include (a) providing a plurality of candidate probe nucleic acid sequences for a genomic region of interest; (b) sorting the plurality of candidate probe nucleic acid sequences from smallest genomic distance to largest genomic distance between neighboring candidate probe nucleic acid sequences to produce a sorted plurality of candidate probe nucleic acid sequences; (c) evaluating a probe property value for a neighboring pair of candidate probe nucleic acid sequences from the sorted plurality to identify a first member of said neighboring pair with a more desirable probe property value than a second pair member of said neighboring pair; (d) removing the second pair member from said plurality; and (e) reiterating the sorting, evaluating and removing steps at least once to produce a final collection of candidate probe nucleic acid sequences. Also provided are methods and systems for selecting one or more candidate probe nucleic acid sequences from a plurality of candidate probe nucleic acids for a genomic region of interest. Aspects of these methods include inputting a request for candidate probe nucleic acids for a genomic region of interest into the system that includes a pairwise elimination ranked record of a plurality of candidate probe nucleic acids for the genomic region; and receiving from the system a subset of the plurality that has been selected from the ranked record in response to, e.g., to match, the request.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As summarized above, aspects of the invention include methods for pairwise filtering of a plurality of candidate probe nucleic acid sequences for a so genomic region of interest. As such, embodiments of the invention include methods of applying a pairwise probe selection process to a plurality of candidate probe nucleic acid sequences for a genomic region of interest.

The phrase “candidate probe nucleic acid sequence” refers to a sequence of nucleotide residues that has been initially identified as a potential nucleic acid sequence that may be present in physical probe nucleic acid (e.g., where the sequence is the sequence of the entire physical probe or a portion thereof, e.g., 50% or more, such as 75% or more including 90% or more in terms of residue number) that could be used in a genomic hybridization assay, such as a comparative genomic hybridization assay or location analysis hybridization assay. In certain embodiments, the candidate probe nucleic acid sequences which are subjected to a pairwise filtering protocol according to an embodiment of the invention are in text format or as a string of text, where the text represents or corresponds to the sequence of nucleotides of the nucleic acid. The nucleic acid sequence can be of any length, e.g., from 15 to 250 nt, such as from 15 to 100 nt, and including from 20 nt to about 60 nt in length. However, nucleic acid sequences of lesser or greater length may be used as appropriate.

The pairwise filtering methods described herein may be viewed as in silico methods, where the term in silico is used as defined above. The methods find use in methods of screening candidate sequences for use in physical probes, e.g., in the form of surface-bound polynucleotides, with binding characteristics that make them suitable for use in array-based genomic assays, such as array-based comparative genome hybridization (aCGH) or location analysis methods. Accordingly, the invention provides a method of in silico screening in which binding of a candidate surface-bound polynucleotide having a candidate sequence of interest is assessed using the methods described above, and candidate sequences with at least predicted desirable binding characteristics are identified. By providing a method of assessing candidate sequences for use in surface-bound polynucleotides, sequences of polynucleotides predicted to have desirable binding characteristics may be readily identified.

Embodiments of the invention are particularly useful with comparative genome hybridization microarrays, such as microarrays based on the human or mouse genome. Such embodiments permit more cost-effective and efficient identification of gene regions or sections which can be associated with human disease, points of therapeutic intervention, and potential toxic side-effects of proposed therapeutic entities.

In general terms, aspects of the methods for pairwise filtering and probe selection of the invention comprise, identifying probe properties that can be determined a priori by the probe's sequence and the sequence of the genome it is contained within, and may further comprise expanding the set of properties from those that can be determined a priori, to those that can be measured empirically through simple experiments, such as self-self experiments. The methods of the invention may further comprise measuring the response of candidate probes to a known stimulus, where the stimulus is generated by a set of samples of where the copy numbers for relatively small subsets of the genome are altered in known ways.

Aspects of the invention include providing a plurality of candidate probe nucleic acid sequences for a genomic region of interest, where the genomic region of interest may be an entire genome of an organism or a portion of thereof, e.g., a chromosome or chromosomal fragment. The genomic region of interest may include a specific target sequence of interest, e.g., a sequence found in a copy number variation (CNV) of interest of a genome (or region thereof, e.g., chromosome or chromosomal segment).

The one or more candidate CGH probe nucleic acid sequences may be provided using any convenient protocol. An example of a suitable protocol is disclosed in published United States Patent Application No. 20060110744 titled: “Probe design methods and microarrays for comparative genomic hybridization and location analysis,”′ the disclosure of which is herein incorporated by reference.

In certain embodiments, candidate probe sequences are initially identified by selecting sequences that comprehensively cover a whole genome (e.g. the human genome), where the entire genomic sequence is searched when generating specific candidate probes. Such methods may include a homology search. In certain embodiments, known highly repetitive sequences can be removed by a process called RepeatMasking. Repeat-masked genomic sequences are publicly available on the web (e.g. UCSC's website having an address produced by placing “www.” before “genomebrowser.org”). Another approach is to reduce the number of probe sequences being searched up-front. This can be done on the basis of any known property of the probe, from thermodynamic properties, such as duplex-Tm and hairpin free energy, to position on the genome. Candidate probe sequences may be selected in terms of “real estate”(number of probes) that is available for a final array that will include the probes. As such, sequence selection may include consideration of the amount of probes or “real estate” to use for specified regulatory regions, intergenic regions as well the amount of probes necessary to adequately cover introns and exons of the chromosomes of interest.

The number of initial candidate probes that is generated may vary considerably. In certain embodiments the number is at least 10, at least 100, at least 1000, at least 10,000, at least 100,000, at least 1,000,000 or more, where in certain embodiments, 3 million or more, 5 million or more, 10 million or more, 20 or more, 50 million or more, 100 million or more, 300 million or more, candidate probe sequences may be initially present in a given plurality of interest. In certain embodiments, the candidate sequences have been selected (i.e., designed) according to one or more particular parameters to be suitable for use in a given application, where representative parameters include, but are not limited to: length, melting temperature (Tm), non-homology with other regions of the genome, hybridization signal intensities, kinetic properties under hybridization conditions, etc., see e.g., U.S. Pat. No. 6,251,588, and Published United Sates Application No. 20040002070; the disclosures of which are herein incorporated by reference.

In general terms, applying pairwise selection of embodiments of the invention includes analyzing neighboring probe sequences within a genomic region of interest, evaluating the pair of neighboring probe sequences for a probe property and then scoring the neighboring probe sequences for the probe property, or properties, of interest. The pairwise filtering algorithm is a protocol of reducing the size of a set of candidate probe nucleic acid sequences (which may be referred to as an initial plurality, to a smaller set of probes, while enriching for a specific beneficial property or properties. In the methods where the pairwise analysis is utilized, the probe property may be selected from the group including, but not limited to: duplex melting temperature, hairpin stability, GC content, if the probe is within an exon, probe is within a gene, probe is within an intron and probe is within a intergenic region, proximity score (e.g., as described in copending application Ser. No.______ filed on even date herewith titled “Methods and Systems for Evaluating CGH Candidate Probe Nucleic Acid Sequences,” and having attorney reference no. 10070135-1), or any property or score for combined properties of the probe or the gene in which it is contained.

In other embodiments, the method may include applying a biased pairwise probe filtering analysis to the candidate probes. Applying a biased pairwise selection algorithm includes, analyzing neighboring probe sequences within a genomic region of interest, evaluating the neighboring probe sequences for a first probe property or group of properties, evaluating the neighboring probe sequences for a second probe property or group of properties and scoring the neighboring probe sequences for the first probe property and weighting this scoring process by the presence or absence of the second probe property. When biased pairwise analysis is utilized, the probe properties of the first and second parameters may be selected from the group which includes, but is not limited to: duplex melting temperature, hairpin stability, GC content, probe is within an exon, probe is within a gene, probe is within an intron and probe is within a intergenic region, proximity score, as well as any second property or score for combined properties of the probe or the gene in which it is contained. Alternatively, the pairwise filtering selection algorithm may utilize a single score which combines multiple properties into a single value for each probe.

Biased pairwise filtering protocols find use in certain applications. For example, there may be reasons other than simple probe performance that drive the selection of probes. For example it may be important to retain probes within genes, within exons of genes, within transcribed or translated regions, etc. There may be differing importance to any of these intervals based on the biology, so the biasing of probe importance may be another important consideration. An enrichment in the number of probes retained for each certain interval can be achieved by adding a biasing values to the scores upon which the probes are selected, hence trading of probe performance for desired content. This type of bias has the advantage of being quantitatively controllable. The larger the bias, the larger is the enrichment. Intervals of greater importance can receive a larger bias values. A second method is to alter the density of the probes in various regions of interest. This latter method was described and invented by Peter Webb in U.S. Patent Publication No. 2006/0110744. In certain embodiments, “locking” probes in place may be employed. With embodiments that “lock” one or more probes in the plurality, it can be assured that a certain probe or set thereof will persist through the pairwise reduction process and be included in the reduced set. This has the advantage of having those desired “locked probes” present during the uniform coverage procedure, rather than added to the plurality non-uniformly following the pairwise filtering. As such, embodiments of the invention include locking at least one member of the plurality so that it is present in said final collection.

Alternatively, applying pairwise selection analysis may comprise selecting a plurality of probe pairs, each probe pair comprising a first probe sequence and a second probe sequence which are adjacent probe sequences within the genomic region of interest, evaluating the first and second probe sequences for at least one probe property, assigning at least one score for each probe property to the first and second probe sequences, and determining which probe sequence of each probe pair comprises the optimum probe characteristics for use in a subsequence genomic hybridization assay, such as an assay which employs a microarray. In some embodiments the probe pairs are randomly selected for pairwise analysis while in other embodiments the probe pairs are selected for pairwise analysis by the order in which they target the chromosome or gene sequence of interest. The order may be assigned in the 3′to 5′direction or 5′to 3′direction. In a preferred embodiment that leads to the construction of more uniformly spaced probe sets, the probe pairs are ordered by the base pair gap size between the first and second probe sequences. Either ordering the pairs by smallest gap distance to largest or largest gap to smallest gap distance.

As such, embodiments of the pairwise filtering protocol of the invention include a step of providing a plurality of candidate probe nucleic acid sequences and then sorting the plurality of candidate probe nucleic acid sequences from smallest genomic distance to largest genomic distance between neighboring candidate probe nucleic acid sequences to produce a sorted plurality of candidate probe nucleic acid sequences. This plurality may be viewed as a distance sorted plurality and provides a list or arrangement of the constituent members of the plurality which is organized according to genomic distance (e.g., in terms of nucleotide residues) of the different members of the plurality. The distance sorted plurality provides information about the closest neighboring pairs on up to the most distant neighboring pairs from each other.

Following production of the sorted plurality, a probe property value for a neighboring pair of candidate probe nucleic acid sequences in the first sorted plurality is then assessed or evaluated, e.g., analyzed, to identify a first member of the neighboring pair with a more desirable probe property value for a given probe property than a second pair member of the neighboring pair. In certain embodiments, the neighboring pair that is evaluated is a pair of candidate probe nucleic acid sequences that is closest to each other in terms of genomic distance in the distance sorted plurality. The pair may be evaluated for the property value or values of interest using any convenient protocol, e.g., by comparing the values of each to each other and assigning a first member of the pair as having a value that is more desirable than a second member of the pair. Depending on the particular probe property or properties of interest, the member of the pair with the higher or lower value may be viewed as more desirable. For example, if a higher value for a probe property indicates a better probe, the member of the pair with the higher value will be identified as being more desirable than the second member of the pair.

Once the more desirable and less desirable members of the pair are identified, the member of the pair (e.g., the second member) that has the less desirable value is then removed, i.e., eliminated, from the plurality. As such, a new plurality which does not include the eliminated candidate probe nucleic acid is produced. Where desired, the method further includes maintaining a record of the order in which candidate probe nucleic acid sequence is removed from the plurality. For example, where the methods include producing pairwise elimination ranked record of a plurality of candidate probe nucleic acids, a record of when the candidate probe nucleic acid is removed from the plurality is made.

Following elimination of one of the members of the pair and prior to any further analysis of pairs in the plurality, the plurality less the first undesirable probe is resorted and then subjected to the pairwise analysis protocol as discussed above. Accordingly, the method includes reiterating the sorting, evaluating and removing steps at least once following removal of the first less desirable probe, where a number of desired iterations is made to produce a final collection of candidate probe nucleic acid sequences. Because the plurality is resorted following elimination of the pair member and prior to any further pairwise analysis, the methods of the present invention differ from those disclosed in United States Patent Application Publication No. 20060110744. In embodiments of the pairwise elimination method described in United States Patent Application Publication No. 20060110744, the candidate probe nucleic acid sequences are sorted by order of the gap size between sequences (i.e., elements), then probes are eliminated starting with the smallest gaps and moving toward the larger gaps until a predetermined number of elements are eliminated (based on the fraction of remaining with the largest gaps). Then, the gaps are recalculated, and sorted and another subset of probes are eliminated. As such, elimination occurs in a “batch mode” with two or more different candidate probe nucleic acid sequences being eliminated prior to any resorting or recalculation of the plurality. In contrast, in embodiments of the present invention, a sorted set of probes is maintained, where the sorted list is recalculated only in terms of the modified distances and scores and ranks “on the fly” (i.e., after each probe is eliminated) when each probe (or element) is eliminated.

In performing the methods of the invention, a sorting protocol may be employed. In certain embodiments, the sorting protocol employed is what may be viewed as a “high-speed” sorting protocol. By high-speed sorting protocol is meant a protocol that sorts 1 million probes in less than 10 minutes on a 3 GHz single-core processor. In certain embodiments, the sorting protocol is one that performs as fast as O(nlog(n)). In certain embodiments, the high-speed sorting protocol is a protocol that maintains a sorted set of candidate probe nucleic acid sequences while recalculating genomic distances following each removal of a candidate probe nucleic acid sequence from the plurality of candidate sequences. In certain embodiments, the sorting protocol that is employed may be referred to as an object oriented protocol. Additional sorting protocols of interest include, but are not limited to: Binary tree sort; Comb sort; Shell sort; Merge Sort; Heap Sort; Quicksort; and Introsort. Embodiments of an object oriented sort and a Binary tree sort are now reviewed in greater detail.

An example of an objected oriented sort is one that is produced as follows from software tools provided within Microsoft's “.NET Framework” library (Redmond, Wash.). In this embodiment, several objects are employed to represent not only the probe sequences and gaps (intervals) between them but also to manage the collections and make referencing the collections more efficient.

The first collection built is an ArrayList (collection of objects with a sequential numeric index; retrieval of objects from this collection can only be performed using the numeric index) containing probe objects that represent all candidate probe nucleic acid sequences selected to cover a certain region. The collection and probe objects are coded as interfaces, so any object implementing these interfaces can be plugged into the algorithm. Once the list is constructed it is sorted by the position property of the probes. Then, one loops over the list of probes in context of their spatial order and creates interval objects. Interval objects represent the distance, or gaps, between two adjacent probe nucleic acid sequences. As intervals are being instantiated, a SortedList object is used to hold the list of distinct interval lengths as keys and counts of intervals of that particular length as values. At the same time, a HashTable is created using the interval lengths as keys and ArrayLists of interval objects as its values. For each newly created interval, the SortedList is checked to see if it contains the interval's length as a key. If the SortedList does not contain the interval's length as a key, a new entry is made in the SortedList and its value is set to one. An entry is also created in the appropriate HashTable using the length as the key and an empty ArrayList as the value. The newly created interval object is then added to that ArrayList. If the key already exists, one then adds one to the count held by the SortedList and adds the interval to the ArrayList that corresponds to the intervals length using the HashTable of intervals. This continues until one has looped over all probes.

Interval objects contain information about the distance between two probes, references to the two probe objects that define its borders, references to the intervals to the immediate right and left, and the status of itself. By referencing the interval objects to their immediate right and left neighbors, a doubly linked list is created that can be used to quickly reference the neighboring intervals. This feature is employed subsequently since once a decision is made to remove a probe, two intervals are condensed into one. It is therefore desirable to be able to reference a neighboring interval quickly (i.e., without scanning a list). Once all intervals have been created, the algorithm loops through all the values of the SortedList and randomizes the order of each ArrayList of intervals.

Once all the collection objects are created, one then proceeds with the pairwise filtering protocol. The class that contains the interval collection objects referred to above resides in a class named cIntervals. This class has a public method that allows the removal of one probe. This method is called a predetermined number of times to reduce the probe count to a certain number or probe density of interest. Each call to the remove a probe in the method results in the following steps:
1. Find the length of the smallest intervals. Done by taking the first element in the SortedList who's value is greater than 0.
2. Retrieve the list of intervals that have that length from the HashTable of ArrayLists.
3. Take the first probe in that randomized list. Keep track of the current position with a static variable.
4. Use a delegate function to compare the two probes that define the end points of the interval. Mark the probes designated by the function as deleted. Where desired, the delegate function checks to see if a probe is locked. In such embodiments, if one probe is locked, the other probe is chosen for deletion regardless of score. In such embodiments, if both probes are locked then neither is removed and you loop back to step 1.
5. Mark the interval as deleted as well, as the one on the same side as the probe that was marked as deleted.
6. Update the SortedList and HashTable of intervals. This means decreasing the counts in the SortedList for the lengths of the two intervals marked as deleted, then adding the information for the new interval. In the SortedList, a new element is created if one does not exist and the count is updated. The element is then added to the linked list for the specific length in the HashTable.
7. Finally, one loops back to step #1 until number of removals is obtained. Then, one loops through the list of probes and collects the ones that have not been marked as deleted.

Where desired, some restrictions may be added to optimize not only how uniform the probes are spaced, but also the quality of probes selected by the filtering protocol. For example, one may limit how large an interval can be created by merging to smaller ones together. Since this reduction method works on probes whose original spacing is not completely uniform, it is desirable to concentrate on areas where probes are denser and not increase large intervals because they might occur next to a small interval. Each time an interval is evaluated for removal a check may be done to see if removing the left probe or the right probe will create an interval that is too large. If so, the algorithm may try to remove the other probe. If it also creates an interval that is too large, then neither probe nucleic acid sequence is removed and the algorithm of this embodiment loops around to find another candidate interval to remove. The maximum interval length is a parameter that can be set at the beginning of the reduction routine (i.e., pairwise filtering protocol). This length can be set to a maximum level and thus have no effect on probe selection if it is desired.

In certain embodiments, a protocol is employed that creates “pseudo” probes. These pseudo probes act as real probes and are placed at a user defined distance into a given gap to allow reduction in a set of probes next to a gap determined by how close the pseudo probe is to the that end of the gap and the maximum interval size. These embodiments are useful where probes right next to a large gap (e.g. the probes on either side of a centromere will typically be far apart) would be effectively locked if a maximum capping length is set and one wants to be able to remove them.

Note that the only step in this process that is O(N log N), where N is the number of probes, is the initial sort of the probes into genomic order. After that, O(N) calls to remove probes are required, but each step is within that call is constant time (e.g. finding neighboring intervals is constant time because of the construction of the double linked list) or at worst O(log N) (maintenance of the sorted list). Other steps are intermediate, depending on detailed implementation (retrieval from a HashTable).

As indicated above, another sorting protocol of interest is a binary tree sorting protocol. In the previous example of an object oriented sorting protocol, the details of the “SortedList” including the mechanism of the sort algorithm are hidden from the user. A second implementation of a suitable sorting algorithm involves the construction of a data structure as the elements of a binary tree, while the tree is constructed using a sort. A binary tree sort is an efficient means of generating or maintaining a sorted set of elements. A binary tree sort provides these features because the number of operations to traverse from the root to the bottom of the tree is usually substantially less than the number of elements within the tree. This feature is particularly true when the root is positioned near the center of the ordered elements, and when their initial order is randomized respect to the metric upon which they are to be sorted.

In the following discussion, for simplicity all the probe properties, as characterized by metrics and scores, will be considered to have been reduced to a single combined score that reflects the probe's performance and its desirability. The following describes an embodiment of a binary tree sort method, as it is employed in embodiments the pairwise elimination methods of the invention. There are many possible implementations involving sorting methods, as discussed above. Below the method with a binary tree sort is described for simplicity, and because it is an efficient sort procedure of order nlog(n).

Before discussing the pairwise filtering method, a review of the properties of a binary tree, and the use of a tree in sorting information, is provided. The origin of a binary tree is its root. Each node is linked to the adjacent node by means of references to the indices (or addresses) of the other nodes, both upward and downward. Each and every node, except the root node, has a reference to a parent node. Each node may have up to two children. Each and every node of the tree is assigned a value or “key”. There can be other information associated with the node than its key. The key information may or may not be unique to each node. In the embodiments discussed here duplicates are allowed. A tree sort works by creating a tree by the addition of new elements to a tree structure one at a time. One considers where to add a new element by starting at the root: the value of the new element is compared with that of the current element. If it is less than the current element, it will be inserted to the left of the current element, otherwise it will be inserted to the right. However, the insertion can only be made at a node that has an available child, either a right or a left child. A left child is created if the new element is lower then the current element and the element has no left child. Similarly an element is added as a right child if the element is equal to or greater then the current element and the right element is available. The process is repeated iteratively, and where desired recursively, until all elements are added to the tree. This process creates an ordered structure, but it is not yet a sorted set of elements. The sort is achieved by traversing a tree from left to right, exploring every branch, while keeping track of all elements whenever a traverse is made to the right. This again may be a recursive procedure.

The binary tree sort is efficient both for sorting a set of objects as well as for maintaining a sort while nodes are added and subtracted from it. This is because for trees with many branches, such as those randomly assembled, there are far fewer steps from the root to any given node than the total number of nodes. As such, finding the optimal location for each new element takes only on the order of log(n) steps rather than n steps, and, similarly for removing a node from the tree.

Turning now to the use of a binary tree sort in the pairwise filtering methods of the invention, each candidate probe nucleic acid sequence (i.e., element) in the plurality of sequences to be filtered is associated with a position and a score. For ease of description, an example with 20 probes, as given in Table 1 below, will be discussed.

TABLE 1
ProbesTable

| ProbeIndex | Position | Score | UpperGap | LowerGap | Rank |
|---|---|---|---|---|---|
| 1 | 71 | 0.712 | 1 | 0 | 0 |
| 2 | 175 | 0.015 | 2 | 1 | 0 |
| 3 | 188 | 0.286 | 3 | 2 | 0 |
| 4 | 246 | 0.724 | 4 | 3 | 0 |
| 5 | 308 | 0.451 | 5 | 4 | 0 |
| 6 | 314 | 0.443 | 6 | 5 | 0 |
| 7 | 342 | 0.473 | 7 | 6 | 0 |
| 8 | 402 | 0.903 | 8 | 7 | 0 |
| 9 | 409 | 0.503 | 9 | 8 | 0 |
| 10 | 412 | 0.805 | 10 | 9 | 0 |
| 11 | 464 | 0.722 | 11 | 10 | 0 |
| 12 | 465 | 0.708 | 12 | 11 | 0 |
| 13 | 491 | 0.394 | 13 | 12 | 0 |
| 14 | 506 | 0.262 | 14 | 13 | 0 |
| 15 | 541 | 0.784 | 15 | 14 | 0 |
| 16 | 587 | 0.282 | 16 | 15 | 0 |
| 17 | 608 | 0.467 | 17 | 16 | 0 |
| 18 | 611 | 0.306 | 18 | 17 | 0 |
| 19 | 621 | 0.664 | 19 | 18 | 0 |
| 20 | 942 | 0.986 | 0 | 19 | 0 |

From the positions in the table, the gaps or distances between adjacent probes are calculated and these gaps are assembled in order by the construction of a binary tree, with the smallest gap arranged on the left and the largest gap on the right, as illustrated in FIG. 1. FIG. 1 shows the gap values to the right of each node, and the node index (in blue) above each node. The gaps are ordered from smallest to largest from left to right. The properties associated with the probes are represented in the ProbesTable. Assembling of the binary Tree is the process of adding each gap element to the Tree structure, which is initially an empty data structure. The gaps between adjacent probes are calculated, and sorted by assembly of a binary tree.

The pairwise filtering method works by maintaining two related data-structures: the ProbesTable and the gap Tree. One considers these structures to be tables, in which the elements are linked by mutual references. The ProbesTable refers to nodes of the Tree by means of the LowerGap and the UpperGap references. The second table is the Tree structure.

TABLE 2
Initial Tree after construction with all gaps.

| Node | Gap | Parent | LeftChild | RightChild | LeftPoint | RightPoint |
|---|---|---|---|---|---|---|
| 1 | 104 | 1 | 0 | 2 | 19 | 1 |
| 2 | 13 | 2 | 1 | 5 | 3 | 2 |
| 3 | 58 | 3 | 2 | 6 | 4 | 3 |
| 4 | 62 | 4 | 3 | 7 | 0 | 4 |
| 5 | 6 | 5 | 2 | 9 | 8 | 5 |
| 6 | 28 | 6 | 3 | 12 | 10 | 6 |
| 7 | 60 | 7 | 4 | 0 | 0 | 7 |
| 8 | 7 | 8 | 5 | 0 | 18 | 8 |
| 9 | 3 | 9 | 5 | 11 | 17 | 9 |
| 10 | 52 | 10 | 6 | 14 | 0 | 10 |
| 11 | 1 | 11 | 9 | 0 | 0 | 11 |
| 12 | 26 | 12 | 6 | 13 | 0 | 12 |
| 13 | 15 | 13 | 12 | 0 | 16 | 13 |
| 14 | 35 | 14 | 10 | 0 | 15 | 14 |
| 15 | 46 | 15 | 14 | 0 | 0 | 15 |
| 16 | 21 | 16 | 13 | 0 | 0 | 16 |
| 17 | 3 | 17 | 9 | 0 | 0 | 17 |
| 18 | 10 | 18 | 8 | 0 | 0 | 18 |
| 19 | 321 | 19 | 1 | 0 | 0 | 19 |

The tree contains the gap or Key value, the references to the probes indices associated with each gap, denoted as LeftPoint and RightPoint, (indices in the ProbesTable) and the Tree index references: Parent, LeftChild and RightChild.

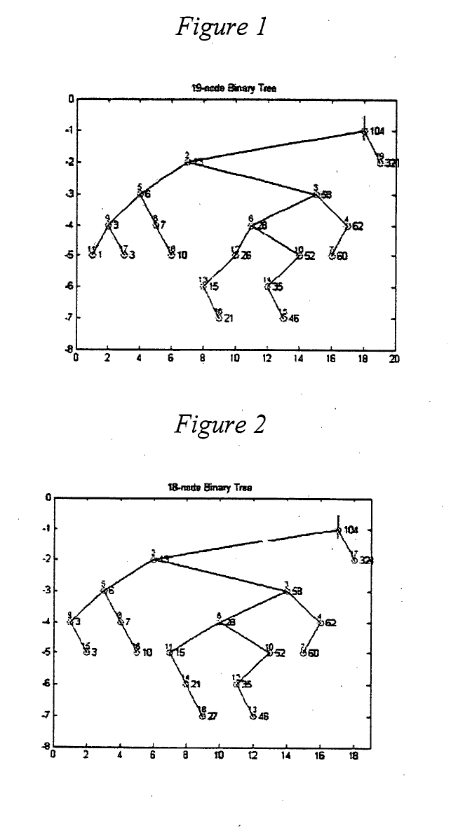

The ranking of probes in the pairwise elimination method is associated with the disassembly of the tree as follows. Starting on the left of the tree, one considers the smallest gap. [In the example, in this case, it node #11 with a gap=1 and it is the root of the tree]. The two probes associated with this node are probes 11 and 12, with scores 0.722 and 0.708, respectively. The second probe, with the lower score, is eliminated, thus eliminating two gaps, nodes #11 and #12, with a gaps equal to 1 and 26, while creating a new larger gap with a value of 27. The elimination of this second gap is achieved by making the branch originating with the node #13 with a gap of 15 the left child of the node #6 with a gap value of 28, eliminating node #12. The new node will be inserted into the Tree as the right child of the node with gap value 21. The first probe to be eliminated is assigned a Rank of 20(equal to the number of probes). The running Rank value is decremented each time a probe is eliminated, and each probe is assigned this running value upon elimination. The new altered Tree structure is shown in FIG. 2.

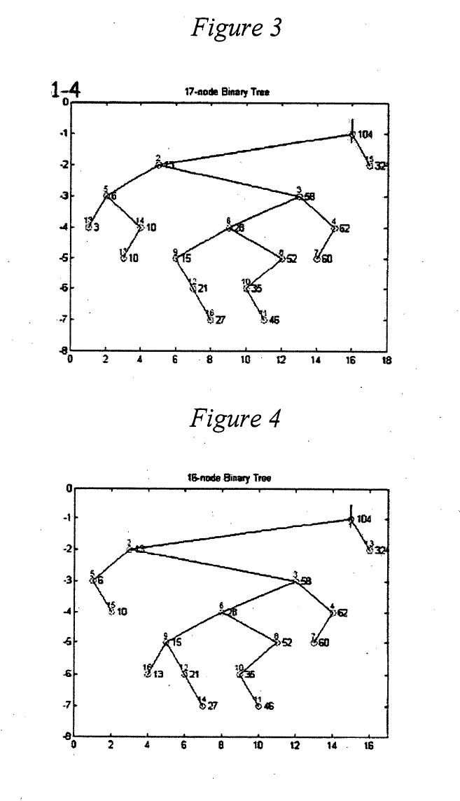

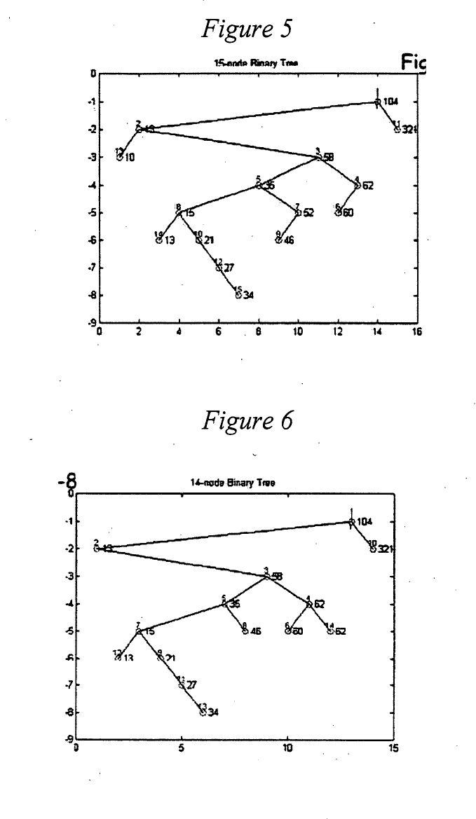

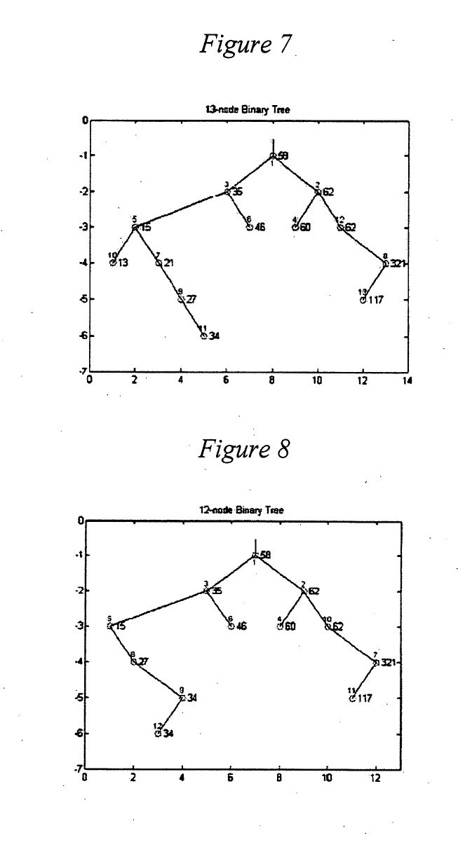

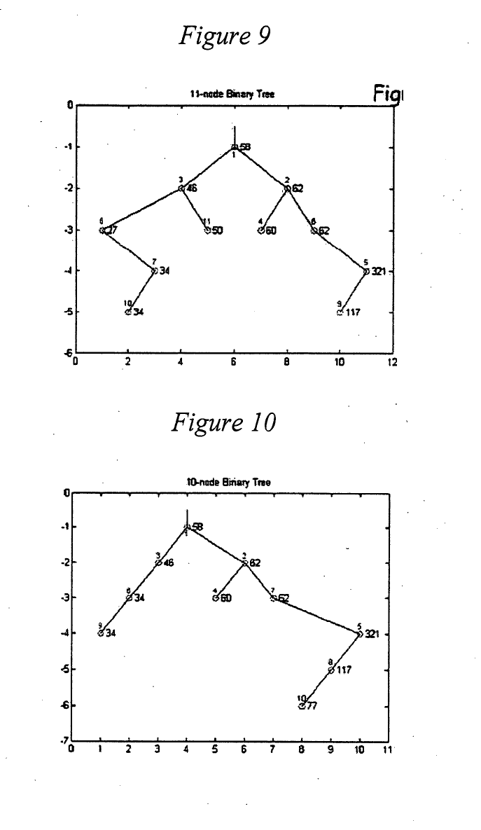

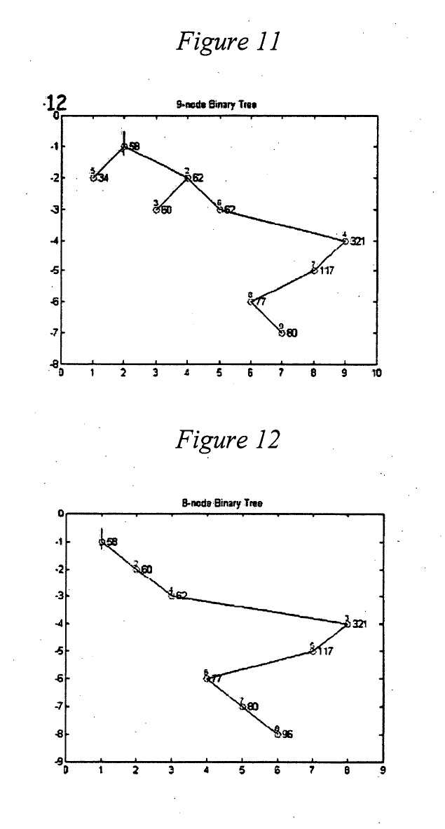

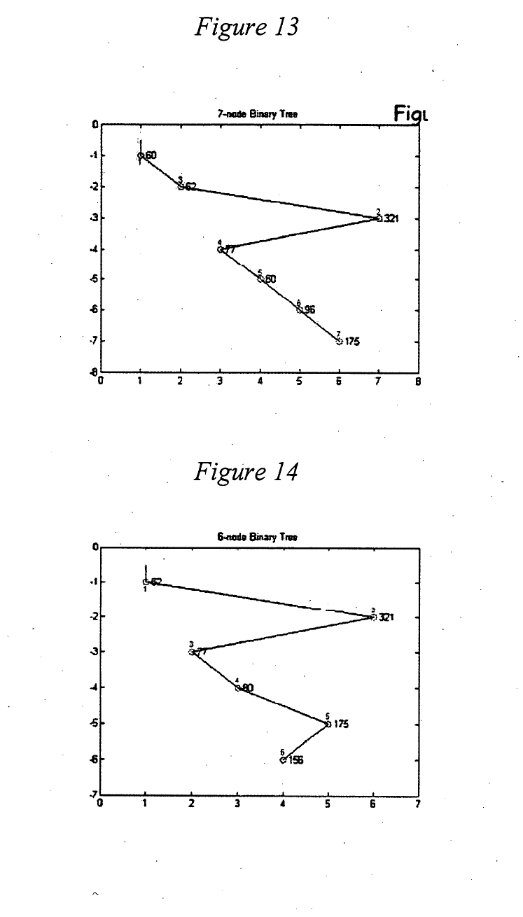

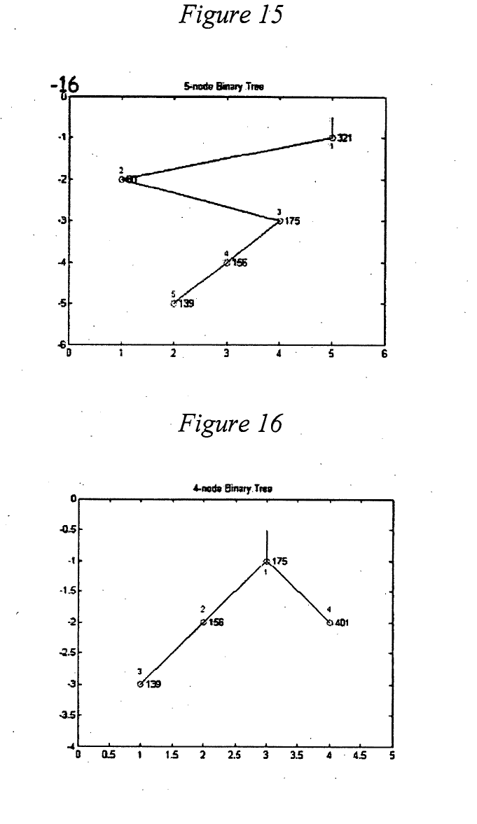

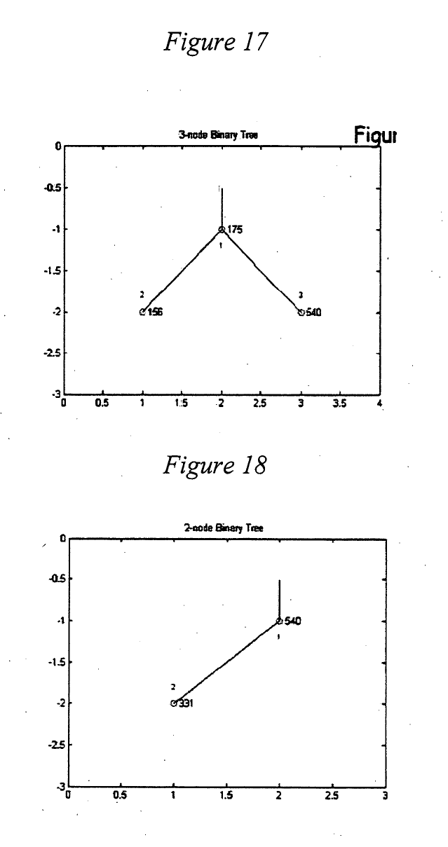

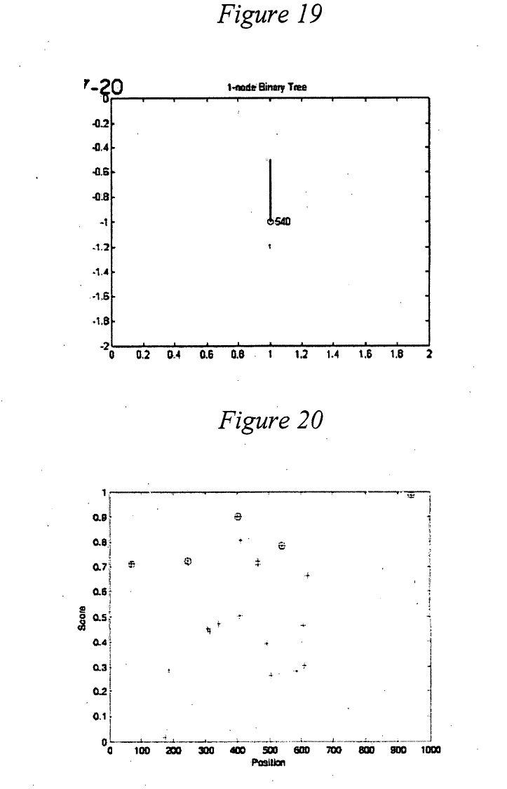

Now, in FIG. 2, we consider the elimination of the next node #9, which has a gap value of 3. This node is associated with probes 9 and 10, with values 0.503 and 0.805. The lower scoring probe (9) is eliminated and assigned a Rank of 19. Again this eliminates two gaps, that between probes 9 & 10 (node #9 with gap=3 in FIG. 2), and another with a gap=7 between probes 8 and 9, (node #8 in FIG. 2). The elimination of node #9 requires that it be replaced in the Tree a new node with a gap=10. This new node is inserted into the Tree as the LeftChild of the node #16 (also gap=10) as shown in FIG. 3. Note that in each figure, the node indices are reassigned.

This process continues until all nodes are eliminated, and only a single probe remains. That last probe is the highest scoring probe and it is assigned a Rank of 1. The final ProbesTable after elimination of all but the last probe is shown in Table 3.

TABLE 3
Final Ranked Example ProbesTable

| ProbeIndex | Position | Score | UpperGap | LowerGap | Rank |
|---|---|---|---|---|---|
| 1 | 71 | 0.712 | 0 | 0 | 3 |
| 2 | 175 | 0.015 | 0 | 0 | 14 |
| 3 | 188 | 0.286 | 0 | 0 | 9 |
| 4 | 246 | 0.724 | 0 | 0 | 5 |
| 5 | 308 | 0.451 | 0 | 0 | 10 |
| 6 | 314 | 0.443 | 0 | 0 | 17 |
| 7 | 342 | 0.473 | 0 | 0 | 8 |
| 8 | 402 | 0.903 | 0 | 0 | 2 |
| 9 | 409 | 0.503 | 0 | 0 | 19 |
| 10 | 412 | 0.805 | 0 | 0 | 16 |
| 11 | 464 | 0.722 | 0 | 0 | 7 |
| 12 | 465 | 0.708 | 0 | 0 | 20 |
| 13 | 491 | 0.394 | 0 | 0 | 12 |
| 14 | 506 | 0.262 | 0 | 0 | 13 |
| 15 | 541 | 0.784 | 0 | 0 | 6 |
| 16 | 587 | 0.282 | 0 | 0 | 11 |
| 17 | 608 | 0.467 | 0 | 0 | 15 |
| 18 | 611 | 0.306 | 0 | 0 | 18 |
| 19 | 621 | 0.664 | 0 | 0 | 4 |
| 20 | 942 | 0.986 | 0 | 38 | 0 |

It can be seen from Table 3, and in FIG. 20 that the top 5 ranked probes have scores above 0.80, where the mean of the whole distribution is only 0.54. If these 5 points are highlighted in FIG. 20, it is apparent that they are typically above their neighbors and reasonably spaced.

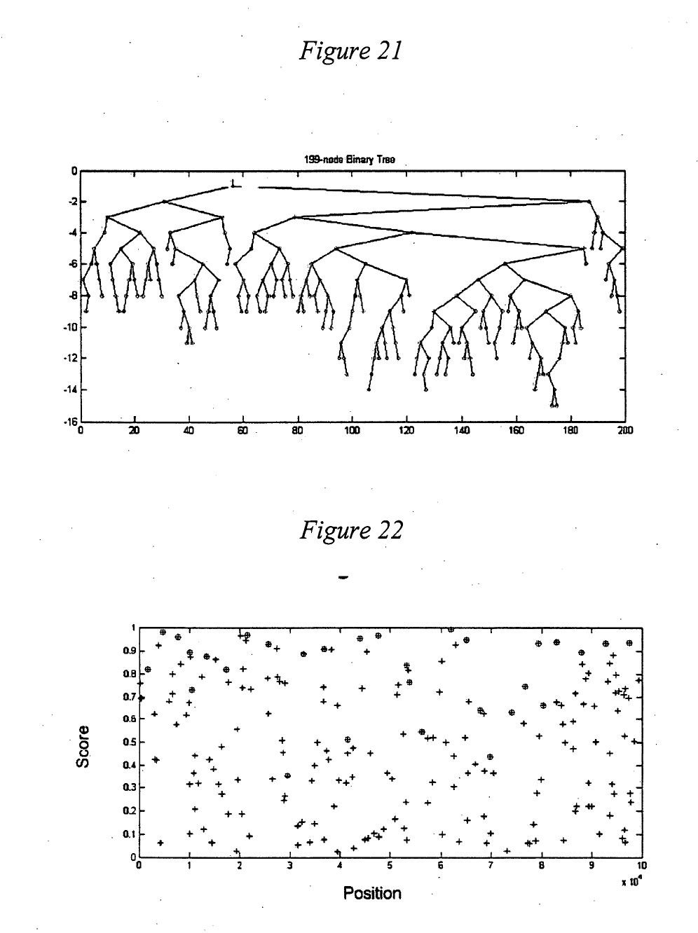

A binary Tree for another example involving 200 randomly generated probes is shown in FIG. 21. All the scores for those 200 probes are plotted against their positions in FIG. 22, with the top 30 probes by selection rank highlighted by circles. The scores of selected probes are typically above the average score value near 0.5, and in those cases where it is not the neighboring probes have even lower scores.

Pairwise filtering as described above provides a result, e.g., a set of filtered candidate probe nucleic acids that has a number of different members which is less than the original number of candidate sequences in the plurality. In certain embodiments, the initial number of candidate probe nucleic acids is about 3.2 billion or less, such as about 44 million or less, including 1 million or less, and the final selected pool of sequences numbers 250,000 or less, such as 44,000 or less including 10,000 or less.

The result may take a variety of different formats, where the information content of the result may be simple or complex. For example, the information content of the result may simply be a list of identifiers of candidate probe nucleic acids that can be employed to obtain the actual sequences of the members in the filtered sets of nucleic acids. Alternatively, the information content of the result may provide additional information, such as the nucleotide sequences of member nucleic acids in the resultant filtered library.

The result is then output in some manner, where the outputting results in a physical transformation of matter physical transformation and/or a useful, concrete and tangible result. For example, the result may be made accessible to a user in some manner so as to make it a tangible result. The result may be made accessible in a number of different manners, such as by displaying it to a user, e.g., via a graphical user interface, by recording it onto a physical medium, e.g., a computer readable medium, and human readable medium, e.g., paper, etc. The above embodiments are merely exemplary.

As reviewed above, the above protocol may be employed to pairwise filter a plurality of candidate nucleic acid sequences, where the plurality may include two or more different candidate sequences, e.g., 10 or more, 50 or more, 100 or more, 1000 or more, 10,000 or more, 50,000 or more, 100,000 or more, 1,000,000 or more different sequences, where in certain embodiments the plurality includes 3 million or more, 5 million or more, 10 million or more, 20 or more, 50 million or more, 100 million or more, 300 million or more candidate sequences.

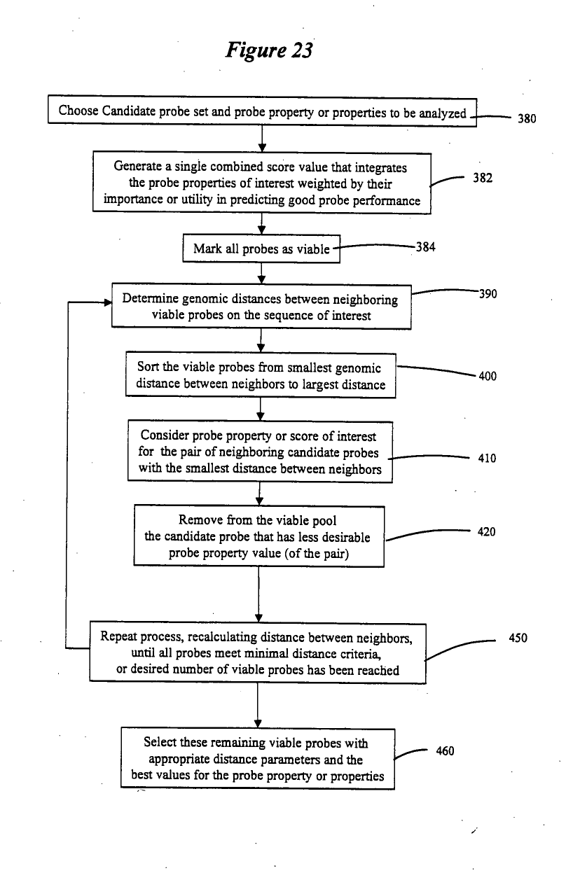

A specific example of a pairwise filtering protocol according to an embodiment of the invention is shown in FIG. 23. Referring now to FIG. 23, a flow chart of the events for one embodiment of the pairwise process for analyzing candidate probes for CGH arrays in accordance with an embodiment of the invention is provided. At event 380, a probe set (e.g. a set of candidate probes within a gene or chromosome of interest) and a probe property are selected for pairwise analysis. An exemplary probe property is the duplex melting temperature of the candidate probes, designated as Tᵢ for each probe. Along with the probe property, an optimal parameter Tₒ value (e.g. the average value of that property among all the candidate probes) is determined. At event 382, a single combined score value is generated that integrates the probe properties of interest weighted by their importance or utility in predicting good probe performance and all probes are marked as viable at event 384.

At event 390, the genomic distances dᵢⱼ between neighboring viable candidate probes within the region of interest, (e.g. on a specified chromosome, or gene of interest) is determined. “Genomic distance” means the number of nucleotide bases separating the two probe positions on the chromosome sequence of interest. The criteria for determining distances include but are not limited to; the distances between pairs of neighboring probes or the average distance of each probe from its two neighbors.

At event 400, the genomic distances between neighboring viable probes are determined, probes N with genomic distances less than a distance D are identified. The candidate probes are analyzed repeatedly for distance measurements until there are no remaining closely spaced probes i.e. dᵢ<D. Two neighboring probes spaced less than a distance D, are given preferential consideration over probe neighbors not meeting this criterion. Candidate probes are sorted from smallest distance between neighbors to largest genomic distance in the embodiment shown in FIG. 23, at event 400.

At event 410, candidate probes of the probe set are analyzed for duplex Tₘ properties. The duplex Tₘ is determined for each probe within a pair using established predictive formulas. In certain embodiments, the pair of probes may be analyzed for a plurality of properties other than Tₘ or in combination with Tₘ determination. In FIG. 23, the probes having a duplex Tₘ value further from Tₒ than that of their neighboring probe are removed or eliminated from the candidate probe set at event 420.

After one round of analysis based on the chosen probe property, i.e. Tₘ in this example, events 390, 400, 410 and 420 are repeated in event 450 until all probes are have met the minimal distance criteria, or until the desired number of probes is achieved. In the subsequent rounds of pairwise analysis the probe neighbors change due to the elimination of some probes not meeting the distance criteria or the accepted values for the probe indicator selected, i.e. Tₘ. Exemplary probe indicators useful in pairwise analysis may include all of the probe selection criteria described above. In event 460, the remaining viable probes with appropriate distance parameters and the best values for the probe property or properties tested are selected.

Embodiments of the above described pairwise filtering protocol can be described summarized as follows:
1. Chose candidate probes over a large genomic region of interest (i.e., genomic interval, such as chromosome, arm of chromosome, genome, etc . . . );
2. Calculate the gaps between adjacent probes on each chromosome;
3. Optionally Randomize or modify the identical gaps
   e.g. add a small random number (<<minimal probe spacing) to the gaps
   e.g. add a small number based on the average of the two adjacent scores
4. Build a sorted list (or Tree) of all gaps between all adjacent probes;
5. Find the smallest gap (or modified gap) and identify neighboring probes;
6. Eliminate one of the two probes with the lower score:
   Assign a Rank order to the eliminated probe,
   Eliminate the gap to the left of the probe,
   Eliminate the gap to the right of the probe.
   Insert a new gap between the probes on both sides of the eliminated probe; and
7. Repeat steps 6 & 7 until either all gaps are eliminated or the desired number of probes is attained.

As indicated above, certain embodiments of the pairwise filtering protocols further include a step of maintaining a record of candidate probe nucleic acids as they are eliminated from a given plurality that is being filtered. Such a record includes, in certain embodiments, information on the order in which a given candidate nucleic acid sequence is eliminated from a plurality that is being filtered. The record may be viewed as a pairwise elimination ranked record of a plurality of candidate probe nucleic acids for a genomic region of interest.

Aspects of the invention further include methods of selecting candidate probe nucleic acids from a system which includes a pairwise elimination ranked record of a plurality of candidate probe nucleic acids for a genomic region. Aspects of such methods include inputting a request for candidate probe nucleic acids for a genomic region of interest into a system, where the system includes a pairwise elimination ranked record of a plurality of candidate probe nucleic acids for said genomic region. The request may vary in terms of content. For example, the request may include a simple number of desired probe sequences. Alternatively, the request may include biasing information, e.g., which probes are to be locked, etc. The ranked record that is present in the system may be one that is generated according to pairwise filtering protocols as described above. In response to the input request, a user receives from the system an output which includes a subset of the initial plurality of candidate probe nucleic acids that are present in the ranked record (i.e., ranked list). The resultant subset is one that has been selected from the record to match said request.

As such, embodiments of the invention include use of precomputed ranked lists or orders of candidate probes sequences, e.g., from the first probe eliminated to the last remaining, or best possible probe. By recording and reversing the order of the probe elimination to produce a pairwise elimination ranked record, one can select a set of any number of reasonably uniformly distributed probes over any arbitrary interval simply by finding those probes with the lowest pre-computed rank over the interval of interest. Thus, the retrieval process implemented desiring to select probes for a given region of interest, instead of requiring customized software (with the pairwise filtering method embedded), instead can merely take advantage of standard database query tools that take the top-ranking set of probes over a range of interest. These selected resultant probes (or elements) are distributed reasonably uniformly over that region and have near optimal performance (or desirability) in each interval.

The above described embodiments provide in silico filtered product sets or pluralities of candidate probe nucleic acid sequences. Resultant in silico sets of candidate probe nucleic acids of interest, e.g., those determined in the evaluation to be “satisfactory” may then be further empirically evaluated. In certain embodiments, empirical evaluation may include synthesizing the physical probes that include the candidate probe nucleic acid sequences of interest and assaying the probes in a hybridization assay. Hybridization assays of interest for these empirical evaluations include contacting an array of candidate probe nucleic acids in the form of surface-bound polynucleotides with a labeled population of nucleic acid acids. Following contact, signals obtained from the surface-bound polynucleotides are compared with a reference, e.g., a previously or concurrently determined control set of values, to evaluate the binding characteristics of one or more of the surface-bound polynucleotides. Examples of empirical assays of interest that may be employed include, but are not limited to: the empirical assays reported in United States Patent Application Nos. 20060110744 and 20070048743; the disclosures of which are herein incorporated by reference. Such assays include assays in which the probes are screened according to at least one experimentally measurable parameter or property, the experimentally measurable property or parameter is selected from the group consisting of signal intensity, reproducibility of signal intensity, dye bias, susceptibility to non-specific binding, wash stability and persistence of probe hybridization. In embodiments where experimentally validating candidate probe performance is used for probe selection, validating the candidate probes comprises hybridizing the candidate probes to a plurality of target sets, evaluating the candidate probes for a probe property for each target set, and comparing the values for probe property of each candidate probe across a plurality of target sets.

The methods described above provide surface-bound polynucleotides with desirable binding characteristics. Once such surface-bound polynucleotides with desirable binding characteristics, i.e., “validated” surface-bound polynucleotides, have been identified, they may be used to fabricate an array. Accordingly, the invention provides a method of producing an array. In general, the method involves identifying a surface-bound polynucleotide with desirable binding characteristic, and fabricating an array containing that polynucleotide. A subject array may contain 1, 2, 3, more than about 5, more than about 10, more than about 20, more than about 50, more than about 100, more than about 200, more than about 500, more than about 1000, more than about 2000, more than about 5000 or more, usually up to about 10,000 or more, “validated” surface-bound polynucleotides.

Arrays can be fabricated using any means, including drop deposition from pulse jets or from fluid-filled tips, etc, or using photolithographic means. Either polynucleotide precursor units (such as nucleotide monomers), in the case of in situ fabrication, or previously synthesized polynucleotides (e.g., oligonucleotides, amplified cDNAs or isolated BAC, bacteriophage and plasmid clones, and the like) can be deposited. Such methods are described in detail in, for example U.S. Pat. Nos. 6,242,266, 6,232,072, 6,180,351, 6,171,797, 6,323,043, etc.

Array platforms of interest include, but are not limited to: United States patents of interest include: U.S. Pat. No. 6,465,182; 6,335,167; 6,251,601; 6,210,878; 6,197,501; 6,159,685; 5,965,362; 5,830,645; 5,665,549; 5,447,841 and 5,348,855. Also of interest are published United States Application Serial Nos. 20020006622; 20040241658 and 20040191813, as well as published PCT application WO 99/23256.

The resultant arrays find use in, among other applications, identifying surface-bound polynucleotides suitable for use in CGH assays, e.g., any application in which one wishes to compare the copy number of nucleic acid sequences found in two or more genomic samples. Once identified, surface-bound polynucleotides suitable for use in CGH assays may be used to make a CGH array, e.g., as described above. Such a CGH array may be used in CGH assays to obtain high quality, reliable, data that is free from the artifacts (e.g. compression of observed ratios due to crosshybridization of surface-bound polynucleotides with non-target sequences) commonly obtained using CGH arrays containing surface-bound polynucleotides identified using other methods. Accordingly, the subject methods find use in making CGH arrays.

One type of application in which the subject CGH arrays find use is the quantitative comparison of copy number of one nucleic acid sequence in a first collection of nucleic acid molecules relative to the copy number of the same sequence in a second collection.

As such, the present invention may be used in methods of comparing abnormal nucleic acid copy number and mapping of chromosomal abnormalities associated with disease. In many embodiments, the subject methods are employed in applications that use polynucleotides immobilized on a solid support, to which differentially labeled nucleic acids produced as described above are hybridized. Analysis of processed results of the described hybridization experiments provides information about the relative copy number of nucleic acid domains, e.g. genes, in genomes.

Such applications compare the copy numbers of sequences capable of binding to the target elements. Variations in copy number detectable by the methods of the invention may arise in different ways. For example, copy number may be altered as a result of amplification or deletion of a chromosomal region, e.g. as commonly occurs in cancer.

Representative applications in which the subject methods find use are further described in U.S. Pat. Nos. 6,335,167; 6,197,501; 5,830,645; and U.S. Pat. No. 5,665,549; the disclosures of which are herein incorporated by reference.

In particular embodiments, CGH arrays containing surface-bound oligonucleotides, i.e., oligonucleotides of 10 to 100 nucleotides and up to 200 nucleotides in length, are employed.

Generally, comparative genome hybridization methods comprise the following major steps: (1) immobilization of polynucleotides on a solid support; (2) pre-hybridization treatment to increase accessibility of support-bound polynucleotides and to reduce nonspecific binding; (3) hybridization of a mixture of labeled nucleic acids to the surface-bound nucleic acids, typically under high stringency conditions; (4) post-hybridization washes to remove nucleic acid fragments not bound to the solid support polynucleotides; and (5) detection of the hybridized labeled nucleic acids. The reagents used in each of these steps and their conditions for use vary depending on the particular application.

As indicated above, hybridization is carried out under suitable hybridization conditions, which may vary in stringency as desired. In certain embodiments, highly stringent hybridization conditions may be employed. The term “high stringent hybridization conditions” as used herein refers to conditions that are compatible to produce nucleic acid binding complexes on an array surface between complementary binding members, i.e., between the surface-bound polynucleotides and complementary labeled nucleic acids in a sample. Representative high stringency assay conditions that may be employed in these embodiments are provided above.

The above hybridization step may include agitation of the immobilized polynucleotides and the sample of labeled nucleic acids, where the agitation may be accomplished using any convenient protocol, e.g., shaking, rotating, spinning, and the like.

Following hybridization, the array-surface bound polynucleotides are typically washed to remove unbound labeled nucleic acids. Washing may be performed using any convenient washing protocol, where the washing conditions are typically stringent, as described above.

Following hybridization and washing, as described above, the hybridization of the labeled nucleic acids to the targets is then detected using standard techniques so that the surface of immobilized targets, e.g., the array, is read. Reading of the resultant hybridized array may be accomplished by illuminating the array and reading the location and intensity of resulting fluorescence at each feature of the array to detect any binding complexes on the surface of the array. For example, a scanner may be used for this purpose, which is similar to the AGILENT MICROARRAY SCANNER available from Agilent Technologies, Palo Alto, Calif. Other suitable devices and methods are described in U.S. Pat. Nos. 6,756,202 and U.S. Pat. No. 6,406,849, which references are incorporated herein by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). In the case of indirect labeling, subsequent treatment of the array with the appropriate reagents may be employed to enable reading of the array. Some methods of detection, such as surface plasmon resonance, do not require any labeling of nucleic acids, and are suitable for some embodiments.

Results from the reading or evaluating may be raw results (such as fluorescence intensity readings for each feature in one or more color channels) or may be processed results (such as those obtained by subtracting a background measurement, or by rejecting a reading for a feature which is below a predetermined threshold, normalizing the results, and/or forming conclusions based on the pattern read from the array (such as whether or not a particular target sequence may have been present in the sample, or whether or not a pattern indicates a particular condition of an organism from which the sample came).

In certain embodiments, the subject methods include a step of transmitting data or results from at least one of the detecting and deriving steps, also referred to herein as evaluating, as described above, to a remote location. By “remote location” is meant a location other than the location at which the array is present and hybridization occur. For example, a remote location could be another location (e.g. office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart. “Communicating” information means transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, internet, etc.

The invention also provides a variety of computer-related embodiments. Specifically, the data analysis methods described in the previous section may be performed using a computer. Accordingly, the invention provides a computer-based system for analyzing data produced using the above methods in order to screen and identify surface-bound polynucleotides with desirable binding characteristics.

In certain embodiments, the methods are coded onto a computer-readable medium in the form of “programming”, where the term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer.

In certain embodiments, the computer readable medium is a medium carrying one or more sequences of instructions for evaluating a candidate probe CGH nucleic acid sequence, wherein execution of one or more sequences of instructions by one or more processors causes the one or more processors to perform the steps of: applying a pairwise filtering protocol of the invention to a plurality of candidate probe nucleic acid sequences; and outputting said result. As such, embodiments of the programming include programming that is configured to cause one or more processors to perform the steps of: (a) sort a plurality of candidate probe nucleic acid sequences for a genomic region of interest from smallest genomic distance to largest genomic distance between neighboring candidate probe nucleic acid sequences to produce a sorted plurality of candidate probe nucleic acid sequences; (b) evaluate a probe property value for a neighboring pair of candidate probe nucleic acid sequences from said sorted plurality to identify a first member of said neighboring pair with a more desirable probe property value than a second pair member of said neighboring pair; (c) remove the second pair member from the plurality; and (d) reiterate the sorting, evaluating and removing steps at least once to produce a final collection of candidate probe nucleic acid sequences.

With respect to computer readable media, “permanent memory” refers to memory that is permanent. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

Aspects of the invention further includes sytems, e.g., computer based systems, that are configured to evaluate a candidate probe nucleic acid sequence. A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware and/or software combination that will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

Embodiments of the subject systems include the following components: (a) a communications module for facilitating information transfer between the system and one or more users, e.g., via a user computer, as described below; and (b) a processing module for performing one or more tasks involved in the probe qualification methods of the invention. In certain embodiments, the subject systems may be viewed as being the physical embodiment of a web portal, where the term “web portal” refers to a web site or service, e.g., as may be viewed in the form of a web page, that offers a broad array of resources and services to users via an electronic communication element, e.g., via the Internet.

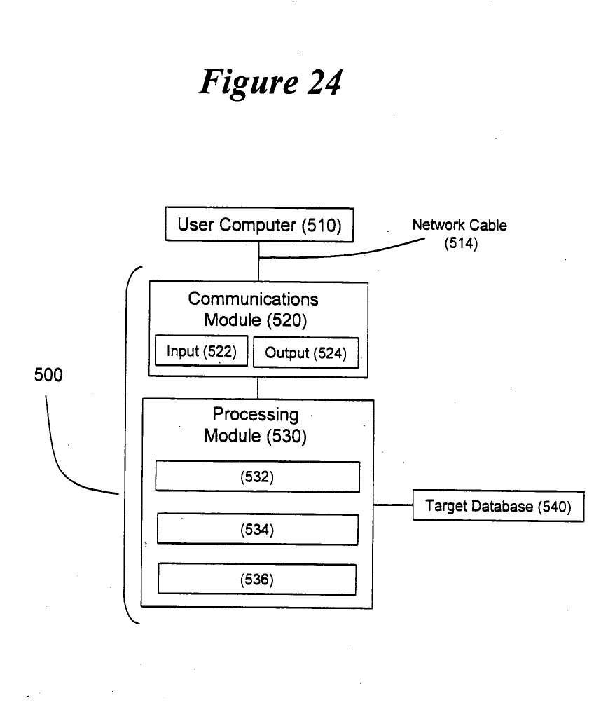

FIG. 24 provides a view of a representative probe qualification system according to an embodiment of the subject invention. In FIG. 24, system 500 includes communications module 520 and processing module 530, where each module may be present on the same or different platforms, e.g., servers, as described above.

The communications module includes the input manager 522 and output manager 524 functional elements. Input manager 522 receives information from a user e.g., over the Internet. Input manager 522 processes and forwards this information to the processing module 530. These functions are implemented using any convenient method or technique. Another of the functional elements of communications module 520 is output manager 524. Output manager 524 provides information assembled by processing module 530 to a user, e.g., over the Internet. The presentation of data by the output manager may be implemented in accordance with any convenient methods or techniques. As some examples, data may include SQL, HTML or XML documents, email or other files, or data in other forms. The data may include Internet URL addresses so that a user may retrieve additional SQL, HTML, XML, or other documents or data from remote sources.

The communications module 520 may be operatively connected to a user computer 510, which provides a vehicle for a user to interact with the system 500. User computer 510, shown in FIG. 24, may be a computing device specially designed and configured to support and execute any of a multitude of different applications. Computer 510 also may be any of a variety of types of general-purpose computers such as a personal computer, network server, workstation, or other computer platform now or later developed. Computer 510 may include components such as a processor, an operating system, a graphical user interface (GUI) controller, a system memory, memory storage devices, and input-output controllers. There are many possible configurations of the components of computer 510 and some components are not listed above, such as cache memory, a data backup unit, and many other devices.

In certain embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein may be accomplished using any convenient method and techniques.

In certain embodiments, a user employs the user computer to enter information into and retrieve information from the system. As shown in FIG. 24, 15 computer 510 is coupled via network cable 514 to the system 500. Additional computers of other users and/or administrators of the system in a local or wide-area network including an Intranet, the Internet, or any other network may also be coupled to system 500 via cable 514. It will be understood that cable 514 is merely representative of any type of network connectivity, which may involve cables, transmitters, relay stations, network servers, wireless communication devices, and many other components not shown suitable for the purpose. Via user computer 510, a user may operate a web browser served by a user-side Internet client to communicate via Internet with system 500. System 500 may similarly be in communication over Internet with other users, networks of users, and/or system administrators, as desired.

As reviewed above, the systems include various functional elements that carry out specific tasks on the platforms in response to information introduced into the system by one or more users. In FIG. 24, elements 532, 534 and 536 represent three different functional elements of processing module 530. While three different functional elements are shown, it is noted that the number of functional elements may be more or less, depending on the particular embodiment of the invention. Functional elements that may be present include, but are not limited to: a pairwise filtering manager configured to perform a pairwise filtering analysis of a plurality of candidate nucleic acid sequences, a probe selection manager configured to configured to select subset of a pairwise elimination ranked record of a plurality of candidate probe nucleic acids for a genomic region in response to a request, etc.

It is noted that the above descriptions was described primarily in terms of embodiments in which the protocols are applied to data ordered in a single spatial dimension. However, the same approach can be extended to multiple dimensions. The main difference for multiple dimensions is that there is no longer a logical ordering of all elements in one dimension. In certain applications, it may not be possible for large sets to store the set of distances between all points. For this reason in such cases, it may be desirable to restrict the searches to small subsets or regions of the multi-dimensional space in determining which elements are in close proximity, and to periodically reconsider the subsets as the number of elements remaining decreases while increasing the sizes of the local regions.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A pairwise filtering method comprising:
(a) providing a plurality of candidate probe nucleic acid sequences for a genomic region of interest;
(b) sorting said plurality of candidate probe nucleic acid sequences from smallest genomic distance to largest genomic distance between neighboring candidate probe nucleic acid sequences to produce a sorted plurality of candidate probe nucleic acid sequences;
(c) evaluating a probe property value for a neighboring pair of candidate probe nucleic acid sequences from said sorted plurality to identify a first member of said neighboring pair with a more desirable probe property value than a second pair member of said neighboring pair;
(d) removing said second pair member from said plurality;
(e) reiterating said sorting, evaluating and removing steps at least once to produce a final collection of candidate probe nucleic acid sequences; and
(f) outputting said final collection.

2. The method according to claim 1, wherein said neighboring pair evaluated in step (c) is a pair that is closest to each other in terms of genomic distance in said sorted plurality.

3. The method according to claim 1, wherein said method further comprises maintaining a record of the order in which candidate probe nucleic acid sequences are removed from said plurality.

4. The method according to claim 1, wherein said method comprises maintaining sorted pairs after each instance in which a pair member is removed from said plurality.

5. The method according to claim 1, wherein said method is performed with high-speed sorting protocol.

6. The method according to claim 5, wherein said high-speed sorting protocol is a protocol that maintains a sorted set of candidate probe nucleic acid sequences while recalculating genomic distances following each removal of a candidate probe nucleic acid sequence from said plurality.

7. The method according to claim 6, wherein said high-speed sorting protocol is an object oriented sorting protocol.

8. The method according to claim 6, wherein said high speed sorting protocol is a binary tree sorting protocol.

9. The method according to claim 1, wherein said probe property value is an in silico determined probe property value.

10. The method of claim 9, wherein said probe property is selected from the group consisting of duplex melting temperature, hairpin stability, GC content, probe is within an exon, probe is within a gene, probe is within an intron, probe is within a intergenic region and a proximity score.

11. The method according to claim 1, wherein said method further comprises locking at least one member of said plurality so that it is present in said final collection.

12. The method according to claim 1, wherein said method further comprises biasing said protocol with respect to a biasing probe property value.

13. The method according to claim 1, wherein said outputting comprises recording information to a physical medium.

14. The method according to claim 1, wherein said method further comprises producing at least one probe nucleic acid having a sequence of a member candidate probe nucleic acid sequence of said final collection.

15. The method according to claim 14, wherein said method further comprises assaying said probe nucleic acid in a hybridization assay.

16. The method according to claim 14, wherein said method further comprises fabricating a nucleic acid array that comprises said candidate probe nucleic acid sequence.

17. The method according to claim 16, wherein said method further comprises contacting said nucleic acid array with a genomic sample.

18. A computer readable medium carrying one or more sequences of instructions for a plurality of candidate probe nucleic acid sequences, wherein execution of one or more sequences of instructions by one or more processors causes the one or more processors to perform the steps of:
(a) sorting a plurality of candidate probe nucleic acid sequences for a genomic region of interest from smallest genomic distance to largest genomic distance between neighboring candidate probe nucleic acid sequences to produce a sorted plurality of candidate probe nucleic acid sequences;
(b) evaluating a probe property value for a neighboring pair of candidate probe nucleic acid sequences from said sorted plurality to identify a first member of said neighboring pair with a more desirable probe property value than a second pair member of said neighboring pair;
(c) removing said second pair member from said plurality; and
(d) reiterating said sorting, evaluating and removing steps at least once to produce a final collection of candidate probe nucleic acid sequences.

19. A system for pairwise filtering a plurality of candidate probe nucleic acid sequences for a genomic region of interest, said system comprising:
(a) a communication module comprising an input manager for receiving input from a user and an output manager for communicating output to a user;
(b) a processing module comprising a pairwise filtering manager configured to:
(i) sort a plurality of candidate probe nucleic acid sequences for a genomic region of interest from smallest genomic distance to largest genomic distance between neighboring candidate probe nucleic acid sequences to produce a sorted plurality of candidate probe nucleic acid sequences;
(ii) evaluating a probe property value for a neighboring pair of candidate probe nucleic acid sequences from said sorted plurality to identify a first member of said neighboring pair with a more desirable probe property value than a second pair member of said neighboring pair;
(iii) removing said second pair member from said plurality;
(iv) reiterating said sorting, evaluating and removing steps at least once to produce a final collection of candidate probe nucleic acid sequences.

20. A method of selecting one or more candidate probe nucleic acid sequences from a plurality of candidate probe nucleic acids for a genomic region of interest, said method comprising:
(a) inputting a request for candidate probe nucleic acids for a genomic region of interest into the system comprising a pairwise elimination ranked record of a plurality of candidate probe nucleic acids for said genomic region; and
(b) receiving from said system an output comprising a subset of said plurality that has been selected from said record to match said request.

21. The method according to claim 20, wherein said request comprises a desired number of probes for a given genomic region.

22. The method according to claim 20, wherein pairwise elimination ranked record is a record of the order in which member candidate probe nucleic acid sequences were eliminated from a plurality during a pairwise filtering of said plurality.

23. The method according to claim 22, wherein said pairwise filtering comprises:
(i) providing a plurality of candidate probe nucleic acid sequences for a genomic region of interest;
(ii) sorting said plurality of candidate probe nucleic acid sequences from smallest genomic distance to largest genomic distance between neighboring candidate probe nucleic acid sequences to produce a sorted plurality of candidate probe nucleic acid sequences;
(iii) evaluating a probe property value for a neighboring pair of candidate probe nucleic acid sequences from said sorted plurality to identify a first member of said neighboring pair with a more desirable probe property value than a second pair member of said neighboring pair;
(iv) removing said second pair member from said plurality; and
(v) reiterating said sorting, evaluating and removing steps at least once to produce a final collection of candidate probe nucleic acid sequences; and
(vi) outputting said final collection.

24. A system for selecting one or more candidate probe nucleic acid sequences from a plurality of candidate probe nucleic acids for a genomic region of interest, said system comprising:
(a) a communication module comprising an input manager for receiving a request for candidate probe nucleic acids for a genomic region of interest from a user and an output manager for communicating output to a user;
(b) a processing module comprising a probe selection manager configured to select subset of a pairwise elimination ranked record of a plurality of candidate probe nucleic acids for said genomic region in response to said request.
